(19) United States
(12) Patent Application Publication
(10) Pub. No.: US 2004/0036247 A1
(43) Pub. Date: Feb. 26, 2004

(54) Method of motion transmission and a wheeled vehicle driven by this method

(76) Inventor: Sheng-Hung Lee, Tainan City (TW)

Correspondence Address: Sheng-Hung Lee, No. 143-3, Ren-Her Rd., Tainan City, 701, TW

(21) Appl. No.: 10/455,191

(22) Filed: Jun. 3, 2003

(30) Foreign Application Priority Data
Aug. 21, 2002 (TW) 091118961
Aug. 23, 2002 (NZ) 520929
Sep. 2, 2002 (NZ) 521101
Sep. 16, 2002 (NZ) 521376

(51) Int. Cl. B62M 1/00

(52) U.S. Cl. 280/221

(57) ABSTRACT

A self-propelled vehicle which can be driven by waist-twisting of human body is disclosed. The vehicle (shown in FIG. 1 and FIG. 11) is like a scooter, but it has a round footboard. Player stands on this round footboard with his two hands gripping the handlebar, and then twists his waist with his heels and toes tilting to force each point of circumference of the footboard to ground on the resisting board in turn. The player's strength of waist-twisting causes circular motion. The circular motion is transmitted to the two driven wheels by the bevel gears to the horizontal axle then drives the driven wheels. In this way, the player's waist-twisting causes the vehicle runs.

### BACKGROUND OF THE INVENTION

1. Field of the Invention

This pioneer invention relates to a self-propelled vehicle that can be driven by waist-twisting and the method thereof. It is specially suitable for the person who needs exercise to develop her (his) waist, hips and thighs with a lot of fun. One of a main field of the present invention is a method of motion transmission which imparts the waist-twisting of human body to a circular motion then drive the vehicle.

To estimate for the future, the present invention will diversely developed into many similar kinds of vehicle which is driven by waist-twisting. It is similar to the inventing of paddles and cranks of bicycle. Early in 1818, someone invented a bicycle. At that age, bicycle was assembled by only two wheels having one handlebar in front. So, people could only slide with a bicycle on road in 1818. Then in 1839, someone invented a pair of paddles and cranks which led the motion of human feet to cause rotary motion to drive bicycles. Therefore, a self-propelled bicycle was invented. The bicycle was driven by a method of motion transmission which imparted motion of human feet into a circular motion then caused bicycles run. Soon, the diversities of bicycle were invented—unicycle, tricycle and the five-wheeled bicycle, and then a stationery bicycle (exercycle). As to the number of rider thereof, the original bicycle evolved a bicycle with two saddles for two persons' riding, for three persons' riding. . . .

Same story happened to the kick scooters. Originally, people can only stand on kick scooters then slide on road. Because of the disclosure of present invention, people then can propel the scooter-liked vehicle by the motion of their waist-twisting.

2. Description of the Related Arts

Several of the prior arts devices have the same function as the present invention. A previous device of waist-twisting exercise for ladies (gentlemen) is shown in FIG. 5. Its main body looks like two overlapped Frisbees. To describe it precisely, the two overlapped plastic discoid boards share one axle inside of and between both of their centers. And several metal balls are embraced between the two discoid boards, and they enable the upper discoid board rotates freely when user twist her (his) waist on this device. As the shown FIG. 2, FIG. 3, FIG. 4 and FIG. 6, the conventional waist-twisting vehicles are driven by the strength from the player's waist-twisting and arm-swinging motion. In other words, the user's arm muscles plus waist muscles make these conventional vehicles move. The moving track of their two front wheels is like a letter “S”. User grips the handlebar by two arms and swings it, then this motion causes the vehicle move forward. Please see the FIG. 7, (prior art D) the reason why these kinds of vehicle are made to move is because the distance of their two front wheels (d) are always shorter than the distance of the two stable rear wheels'. (D) A rider twists his waist with his two hands gripping the handlebar and swings his two arms to cause the vehicle to move by the strength of waist through the rider's arm muscles. This is the method of motion transmission of the prior art. Obviously, it is different to the method of present invention's method.

### SUMMARY OF THE INVENTION

The problem which the invention is to solve is to create a more beautiful waist-twisting posture than the prior arts do and bring an entertainment that prior arts never do. By this way of the present invention, waist-twisting exercise becomes a popular outdoor sport. Besides, people can have a lot of fun when they are doing or watching this exercise in a group or in a specially designed game. The prior art of waist-twisting exercisers make the users horizontally twist their waists. Frankly, it's not a beautiful charming posture. So ladies do the waist-twisting exercise only inside of their house with the prior art shown in FIG. 5. These conventional waist-twisting exercisers really bring a boring homework to the users. That doing exercise is a kind of homework is an old concept. Nowadays, people like to have much more fun. But most of the modernized people have limited time to do exercise and have a few times to have entertainment. The present invention combines entertainment and exercise together. Therefore, players can have well-proportioned figure in a short term and have lots of fun instantly when doing this exercise.

The object of the present invention is to provide a wheeled vehicle propelled by waist-twisting then the users can have a beautiful posture of Hawaiian hula style. In this way, users can save much of time by combining exercise and entertainment together and have a well-proportioned figure in a short term.

In one form of the invention, the scooter-liked vehicle driven by twisting of human waist comprises: a main body frame with five wheels; a shaft with a coupler of ball-shaped top end, with its bottom end firmly welded on middle of said main body frame; a round footboard with a receiving coupler in centre thereof coupling to said ball-shaped top end; a resisting board configured under said footboard, with at least an annular shape of plane surface; a driver unit, including at least one rotatable wheel and corresponding axle therein, and at least one supporting body to support said axle, said driver unit configured between said footboard and said resisting board, and with at least one rotatable wheel withstanding said footboard, enabling said footboard to depress said driver unit then push said driver unit to move; a rotation arm with a first end coupled to said shaft by rotary coupler, with a second end joined said driver unit; a set of mechanism for motion transmission, including at least one free wheel, and with one element driven by said rotation arm.

The method of driving the vehicle is to stand on said footboard and twist waist, and then tilt heels and toes to force each point of circumference of said footboard to ground on said resisting board in turn, and meanwhile, said footboard depresses said driver unit sideways in a same direction, therefore said driver unit moves tangentially toward the highest point on the circumference of said footboard then drives said rotation arm to produce circular motion. The circular motion of said rotation arm is transmitted to the two driven wheels. In this way, waist-twisting strength causes the vehicle runs.

### BRIEF DESCRIPTION OF THE DRAWINGS

FIG. 1 is a perspective view showing one example of the present invention. (Front Page View) The D.O.S arrow is direction of sight for cross sectional views in FIGS. 10,19,20,21, and 22. All their broken line is same, from I to II cut along the horizontal axle 70 of the main body.

FIG. 2 is a perspective view of prior art A.

FIG. 3 is a plane view of prior art A.

FIG. 4 is a perspective view of prior art B.

FIG. 5 is a perspective view of prior art C.

FIG. 6 is a perspective view of prior art D.

FIG. 7 is a bottom view of the prior art D.

FIG. 8 is a perspective view of the universal joint 150 and upper end 181 of shaft 180. Said universal joint 150 joins the inner ring 153 of ball bearing 155. Outer ring 154 of said ball bearing 155 is to be secured firmly by a hole of footboard. The bottom end 157 of said universal joint 150 firmly joins the upper end 181 of said shaft 180 by a sleeve body 158. (In claim 2:” The self-propelled vehicle according to claim 1, wherein the upper end 181 of said shaft 180 couples to centre of said footboard (not shown in this drawing, please see FIG. 22 as a reference for footboard D60.) by a universal joint 150 and a ball bearing 155, inner ring 153 of said ball bearing 155 secures top end 152 of said universal joint 150, and outer ring 154 of said ball bearing 155 is secured by a hole in centre of said footboard D60, enabling the under surface 150L (22L in FIG. 22) of said footboard C60 tilt around joint point 159 of said universal joint 150.”)

This universal joint 150 can also be configured in the embodiment in FIG. 11 to replace the ball-shaped top end 81 of shaft 80 and the receiving coupler 63,64,65,66 (Shown in FIG. 15) of footboard 60.

FIG. 9 is a perspective view of the “driver unit” with three rotatable wheels.

It can be configured in the embodiment in FIG. 11 to replace the driver unit 74,75,202. The second end 202 of rotation arm 20 is to join the hole 171H to support the driver unit 170. The rotatable wheel 174 is to withstand the footboard 60. The two rotatable wheels 175, 176 are to ground on the resisting board 13 and roll tangentially to a circumference track 60T (The circumference track 60T is shown in FIG. 11.) The 176T and 175T are tracks of the two rotatable wheels 175,176 in tangent line. A pair of supporting body 172,173 is slightly bended to make the two rotatable wheels roll in a tangent line 176T, 175T respectively then efficiently.

In claim 9.: “The self-propelled vehicle according to claim 1, wherein said driver unit 170 has at least two rotatable wheels (the driver unit in FIG. 13), with said supporting body 172 joined said second end of rotation arm.”

FIG. 10 is a cross sectional view of another embodiment (The shaft D80, the driven wheels D21,D22 and horizontal axle D701 are not cross sectional. The broken line is from I to II cut along the horizontal axle of the main body.): One point D201 on the circumference of fly wheel D15 joins a first end D201 of a rotation arm D20. The driver unit D70 joins a second end D202 of rotation arm D20 to support one rotatable wheel D21 to withstand footboard D60. A discoid body shell D13 joined the shaft D80 in centre thereof

In claim 12.:” The self-propelled vehicle according to claim 10, wherein a set of motion transmission mechanism with one element D15 driven by said rotation arm D20, said element is a fly wheel D15 coupling to said shaft D80 with a coupler of free wheel D95 or a ratchet.”

In claim 13.: “The self-propelled vehicle according to claim 10, wherein said rotation arm D20 with a first end D201 joined one point D201 on circumference of said fly wheel D15, with a second end D202 joined said driver unit D70.”

The centre bore D151 of fly wheel D15 firmly secures to a bevel gear D50. Centre bore D501 of said bevel gear D50 then couples to a shaft D80 by a freewheel D95.

FIG. 11 is an exploded view of the present invention in a preferred embodiment.

FIG. 12 is a perspective view of the other proposal of the “driver unit”. It can be configured in any of the present inventions in FIGS. 10,20,21 or 22 to replace their driver units D70, A70,B70 or C70.

In claim 13.: “The self-propelled vehicle according to claim 10, wherein said rotation arm F20 with a first end F201 joins one point on circumference of said fly wheel, joins said driver unit F170 by a second end F202 thereof.” (The hole F201 is to join the circumference of fly wheel 15 by screw.)

FIG. 13 is a perspective view of the other proposal of the “driver unit”. It can be configured in the embodiment shown in FIG. 11. (and FIG. 14) to replace the driver unit 74,75,202. The square hole 2711H is to join the second end 202 (FIG. 14) of rotation arm 20.

FIG. 14 is an exploded view of the assembly of rotation arm 20 and driver unit 74,75,202. The first end 201 of said rotation arm 20 secures a freewheel 95 by a screw 93 and a tenon joint 92,94. The ring 99 with thread 991 is to fasten the top end 504 (in FIG. 16) of bevel gear 50 then assemble rotation arm unit 20,95,99.

It is an assembly of the embodiment in FIG. 11.

FIG. 15 is a cross sectional view of the receiving coupler 63,64,65,66 in centre 61 of footboard 60, said receiving coupler 63,64,65,66 couples to top end 81 of the shaft 80.

In claim 3: “The self-propelled vehicle according to claim 1, wherein the upper end 81 of said shaft 80 is a ball-shaped head 81, said receiving coupler 63,64,65,66 is composed by at least two blocks of bushes 63,64,65,66.”

FIG. 16 is a bottom perspective view of the assembly of the shaft 80, bevel gears 50 and 51, main body frame10, horizontal axle 70, ball bearings 701,702,703,704 and the two driven wheels 21,22. The squared neck 508 of bevel gear 50 is to be secured by a fly wheel 15 (shown in FIG. 11).

This drawing shows a bracket assembly of the preferred embodiment in FIG. 11.

FIG. 17 is a cross sectional view of the centre portion of the present invention in preferred embodiment of FIG 11.

A free wheel 95 fastened by a threaded ring 99 to assemble the first end 201 of rotation arm 20, the squared neck 508 of bevel gear 50 and the fly wheel 15 together. 505 and 506 are ball bearings. 13 is a discoid body shell.

FIG. 18 is a cross sectional view of the centre portion of the present invention in preferred embodiment of FIG. 11.

FIG. 19 is a cross sectional view of main body of the embodiment in FIG. 11. (The shaft 80, the driven wheels 21,22 and horizontal axle 70 are not cross sectional. The broken line is from I to II, cutting along the horizontal axle of the main body.)

In claim 7.: “The self-propelled vehicle according to claim 1, wherein said rotation arm 20 extending with angle of elevation, with a first end 201 coupled to said shaft 80 by rotary coupler 95, with a second end 202 joined said driver unit E70,74.”

In claim 8.: “The self-propelled vehicle according to claim 7, wherein said driver unit E70 has one rotatable wheel 74, said second end 202 of rotation arm acts as an axle 202 of said rotatable wheel 74.”

FIG. 20 is a cross sectional view of main body of another embodiment (The shaft A80, the driven wheels A21,A22 and horizontal axle A701 are not cross sectional. The broken line is from I to II, cutting along the horizontal axle of the main body.):

The first end A201 of rotation arm A20 joins the circumference of fly wheel A15. Said driver unit A70 has two rotatable wheels A74,A75. A free wheel A95 is firmly secured by round centre bore A151 of fly wheel A15. The inner ring A951 of said free wheel A95 secures the bevel gear A50. And the centre bore A502 of bevel gear A50 secures the shaft A80 by ball bearing A505.

In claim 1,”. . . . g) a set of mechanism for motion transmission, including at least one free wheeler A95, and with one element A50 driven by said rotation arm A20,”

FIG. 21 is a cross sectional view of main body of another embodiment (The shaft B80 and the horizontal axle B701 are not cross sectional. The broken line is from I to II, cutting along the horizontal axle of the main body.):

The first end B201 of rotation arm B20 joins said fly wheel B15, said second end B204 of rotation arm B20 joins driver unit B70. Said driver unit B70 has one rotatable wheel B74. Two ball bearings B95,B96 are secured by centre bore B501 of bevel gear B50; squared centre bore B151 of fly wheel B15 firmly secures bevel gear B50.

Two free wheels B211,B221 are configured in the bore centers B212,B222 of the two driven wheels B21,B22 separately

In claim 1,”. . . . g) a set of mechanism for motion transmission, including at least one free wheeler B21,B22, and with one element B50 driven by said rotation arm B20,”

In claim 16: “The self-propelled vehicle according to claim 1, wherein a set of mechanism for motion transmission, including free wheels B21,B22 configured in said driven wheels respectively.”

FIG. 22 is a cross sectional view of main body of another embodiment (The driven wheels C21,C22 and horizontal axle C701 are not cross sectional. The broken line is from I to II cutting, along the horizontal axle of the main body.):

The driver unit C70 has one supporting body C72 to support two rotatable wheels C74,C75. The centre hole of footboard C66 secures outer ring 54 of a ball bearing C155. Inner ring C156 of said bail bearing C155 secures top end C152 of a universal joint C150. Bottom end C157 of said universal joint C150 couples to the top end C81 of shaft C80 by a ball bearing C159. Therefore, the shaft C80, is a rotation centre for a fly wheel C15. The centre bore C151 of fly wheel C15 firmly secures to a bevel gear C50. Centre bore C501 of said bevel gear C50 couples to a shaft C80 by a free wheel C95. Centre of a discoid body shell C13 joins said shaft 80.

The joint point C1 of said universal joint C150 should always be arranged on the level 22L of lower surface C69 of footboard centre C61. Only in this arrangement, the centre point C61 of footboard C60 will be a centre of tilting and grounding then depress driver unit C70 well.

In claim 2: ” The self-propelled vehicle according to claim 1, wherein the upper end C81 of said shaft C80 couples to centre C61 of said footboard C60 by a universal joint C150 and a ball bearing C155, inner ring C156 of said ball bearing C155 secures upper end C152 of said universal joint C150, and outer ring C154 of said ball bearing C155 is secured by a hole C66 in footboard centre C61,”

FIG. 23 is a perspective view of the present invention with a function of linkage on its front portion 14. (Please compare to FIG. 11) The bicycle-liked detachable steering device 30 is detached. Instead, a special designed front wheel unit 230 with a function of linkage is assembled to its front portion 14.

FIG. 24 is a plane view of the present invention with a function of linkage on its rear portion 218. The tail coupler 217 has an hole 216 to couple to a short stem 232 of the vehicle in FIG. 23. The vehicle of FIG. 23 is to link to the vehicle of FIG. 24 in line. In this way, two riders can choose to play together.

FIG. 25 is a perspective view of the Siamese twin vehicle.

FIG. 26 is a perspective view of the resisting board for the Siamese twin vehicle.

### DETAILED DESCRIPTION OF THE PREFERRED EMBODIMENT

The present invention refers to two categories: one is the method of transmitting the human waist-twisting strength into a circular motion; the other is the mechanism of a vehicle which is to support this method.

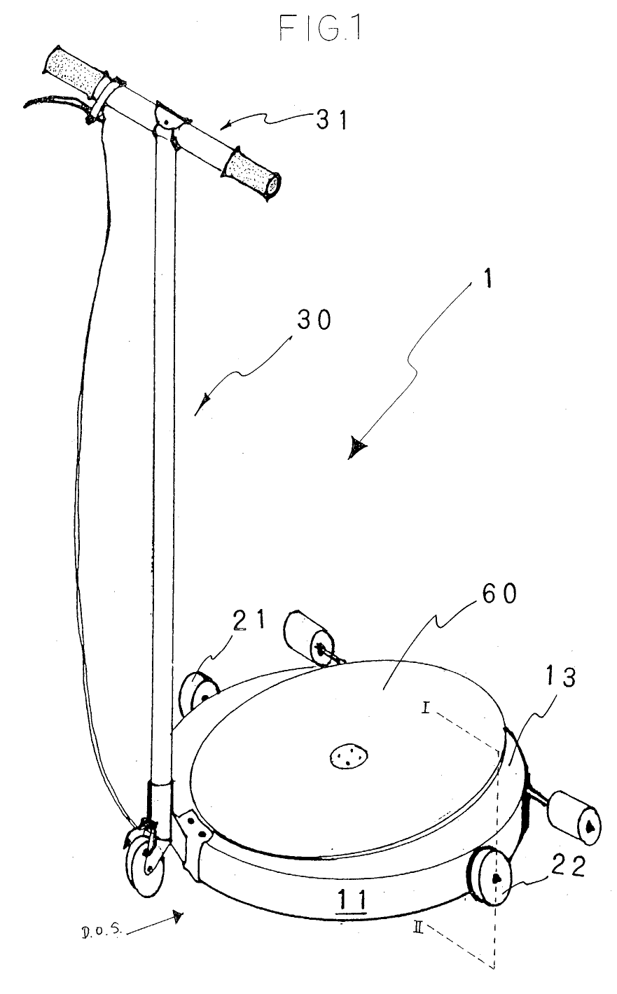

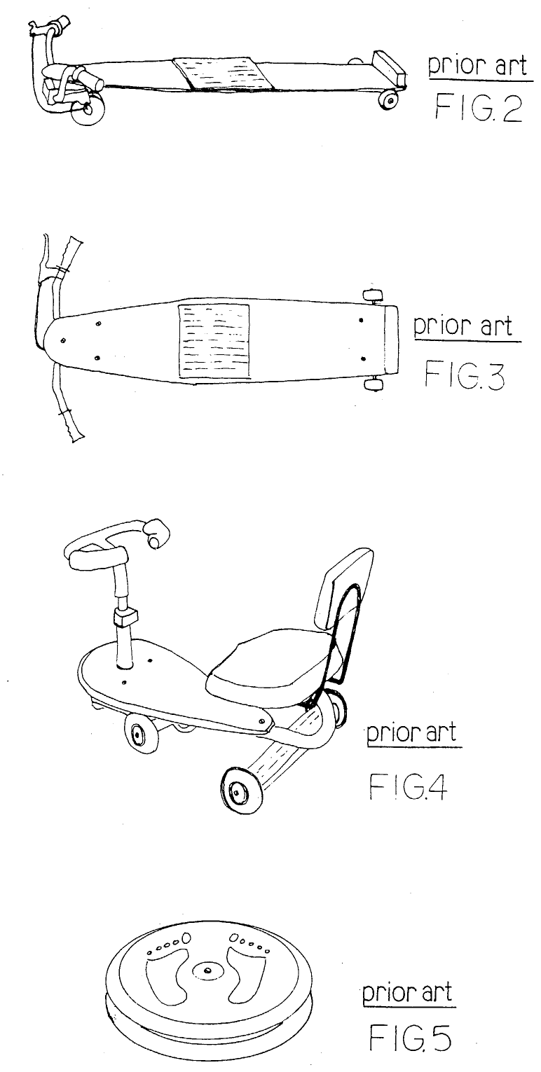

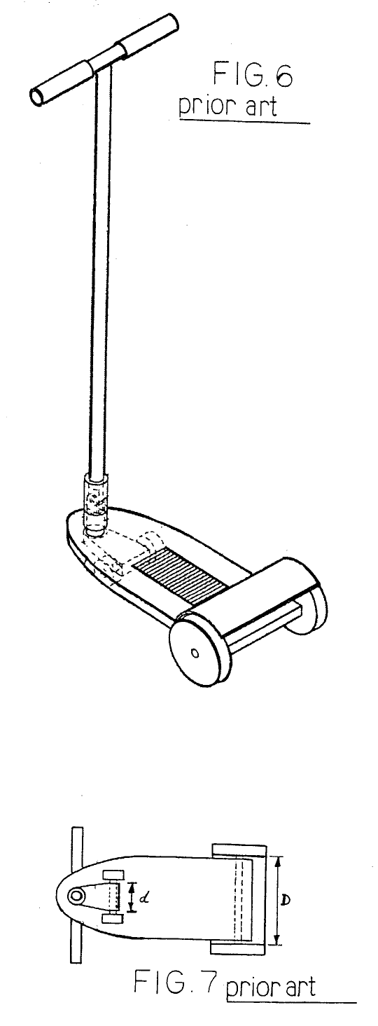

One preferred embodiment is shown in FIG. 1. And its exploded view is shown in FIG. 11. A main body frame 10 is covered by a resisting board 13 above, and surrounded by a drum-shaped shell 11. The two castor trailing wheels 23,24 are assembled to the drum-shaped shell.11 The forward most 14 of said resisting board 13 engages a detachable steering device 30-a steering wheel 25, a handlebar 31 and a handlebar stem 32 extending through a steering column 33 which is incorporated with the forward most 14 of drum-shaped shell 11 with screws 34 and nuts 35. The handlebar 31 is mounted by a brake lever 41 of bicycle with cable 42 linking to brake shoes 43—all the brake kit members 40 are the same as bicycles'.

A shaft 80 vertically extends through a hole 12 in the middle of said resisting board 13 and extends through a square centre bore 16 of a fly wheel 15. The upper end 81 of said shaft 80 is a ball-shaped top end 81. Please also see FIG. 15. The ball-shaped top end 81 joins the centre 61 of said footboard 60 with four blocks of bushing 63,64,65,66 which are secured by a hole 62 caved in the centre 61 of the footboard 60 with two round plates 67,68 stabilized by screws 601,602 and nuts 603,604.

Please also see FIG. 14. The first end 201 of a rotation arm 20 couples to a free wheel 95 with screw 93 and tenon joint. 92,94 (This free wheel 95 is like the one configured in rear hub of a bicycle. The only difference is that, instead of chain teeth, it has only one tenon 94 on its circumference 98.) Inner ring 96 of the free wheel 95 secures the upper end 501 of a hollow bevel gear 50 by thread 96 thereof (also shown in FIG; 17 and FIG. 18) Centre bore 502 of said hollow bevel gear 50 secures around said shaft 80 by ball bearing 505 and ball bearing 506. Said rotation arm 20 inclines and extends over the resisting board 13 with a second end 202 secured by a rotatable wheel 74 with a ball bearing 75. (shown in FIG. 14) In other words, the second end 202 of the rotation arm 20 tapers and becomes a rotatable wheel's axle 202. This rotation arm 20 enables the rotatable wheel 74 to keep withstanding in a high position 622 (also shown in FIG. 19) on the circumference of said footboard 60. Therefore, when a player stands on the footboard 60 to twist waist and tilt his heels and toes, the wheel roller 74 is depressed sideways by the footboard 60 then move circularly.

A bevel gear 50 embraces ball bearings 505 and 506 in its centre bore 503 then rotationally couples to the vertical shaft 80. (also shown in FIG. 17 and FIG. 18) Besides, the upper portion 504 (FIG. 17) of the bevel gear 50 is secured by the inner ring 96 of the free wheel 95 by their threads 96 and they are tightened by a threaded ring 99 with female-thread 991. (FIG. 14) Under the male-threaded portion 507 of bevel gear 50, it's neck is cut into a square shape 508. (also shown in FIG. 16). The square-shaped neck 508 is secured by the square-shaped centre bore 16 of a discoid metal plate 15 which acts as a fly wheel 15. By this arrangement of fly wheel 15, the circular motion imparted from the rotation arm 20 can be stabilized and balanced.

Under the resisting board 13, the teeth 509 of bevel gear 50 engages the teeth 519 of bevel gear 51 (also shown in FIG; 16) Bottom end 83 of the shaft 80 is welded firmly on a bridge-shaped supporting metal 84. (also shown in FIGS. 17, 18) Thereby, the vertical shaft 80 can afford a space for the horizontal axle 70 to extend across underneath. And centre bore 513 of the bevel gear 51 secures a horizontal axle 70 firmly with a tenon joint 511. The horizontal axle 70 extends and crosses the main body frame 10 and the drum-shaped body shell 11 with ball bearings 701,702,703,704. (also shown in FIG. 16) Centre bore of the two driven wheels 21,22 are secured firmly to the two axle ends 700,705 respectively.

When a player stands on this vehicle with his two hands gripping the handlebar 31, and twisting his waist, and then tilts heels and toes to force each point of circumference of the footboard 60 to ground on the resisting board 13 in turn. Meanwhile, said footboard 60 depressing said driver unit 70 sideways in a same direction. Therefore said driver unit 70 moves tangentially toward the highest point on the circumference of said footboard 60 then drives said rotation arm 20 to produce circular motion around said shaft 80. The circular motion of rotation arm 20 is transmitted to the two driven wheels 21,22 by the bevel gear 50 and the bevel gear 51 through the horizontal axle 70. In this way, player's waist-twisting motion causes the vehicle to run.

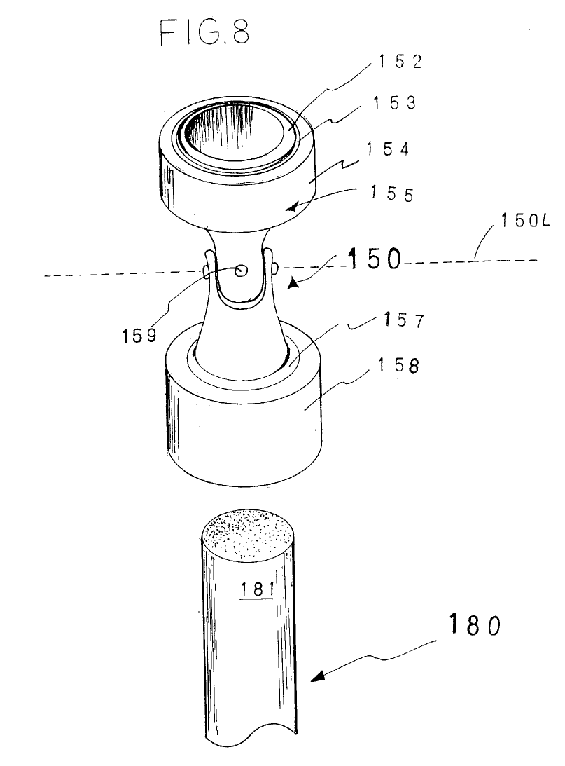

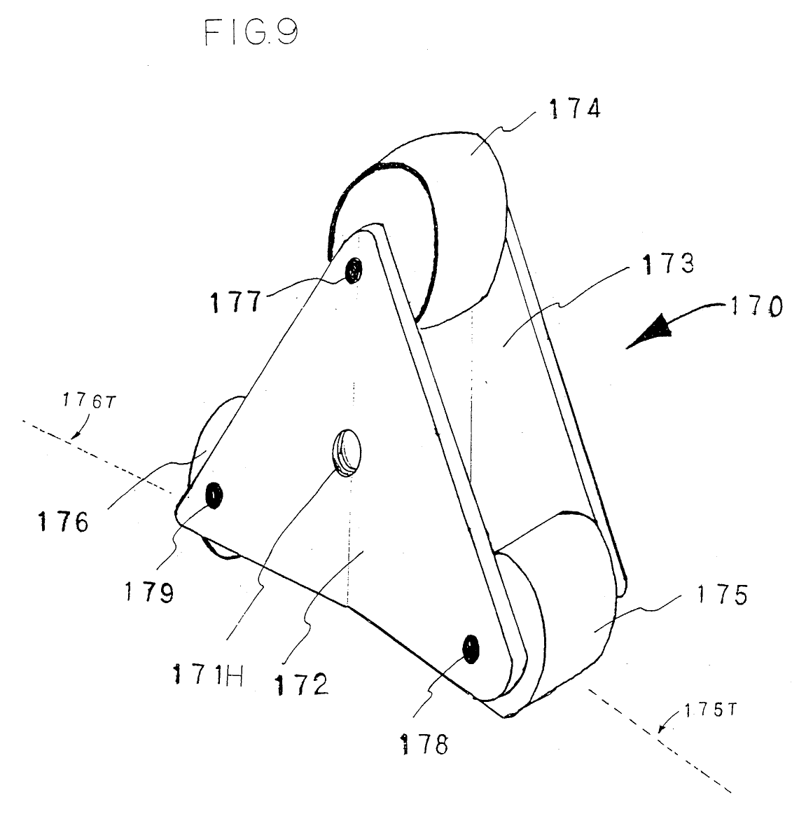

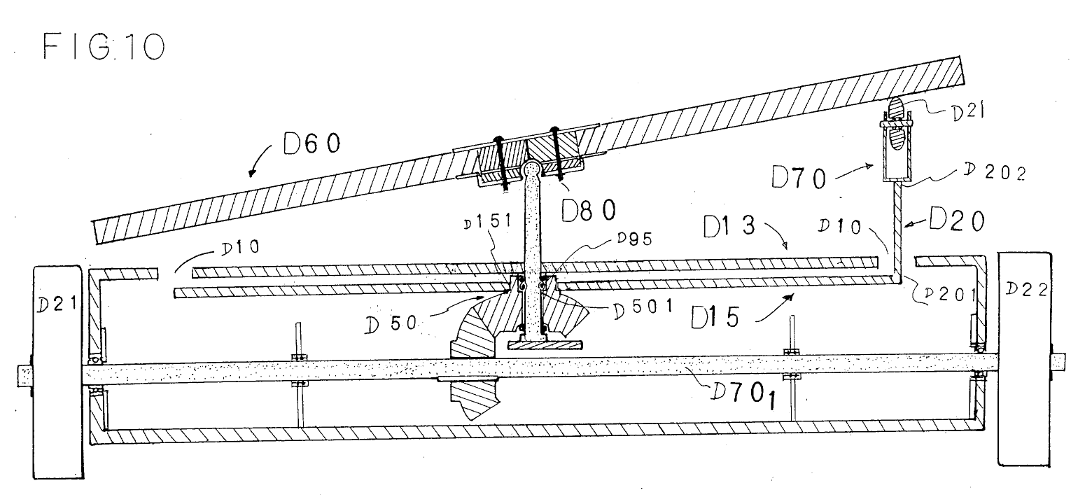

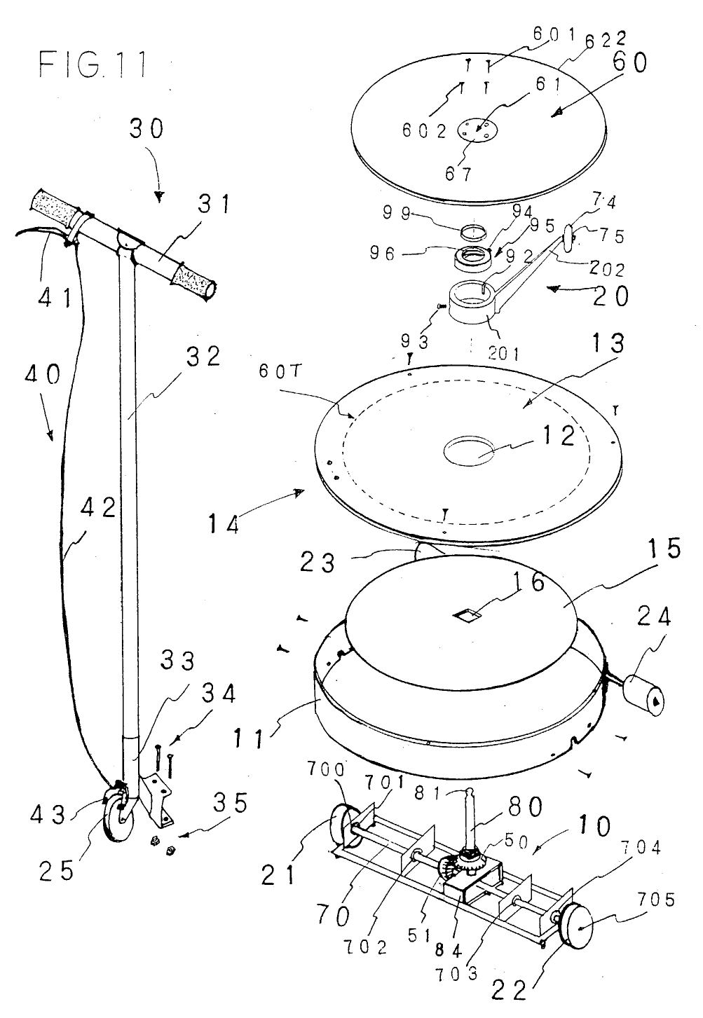

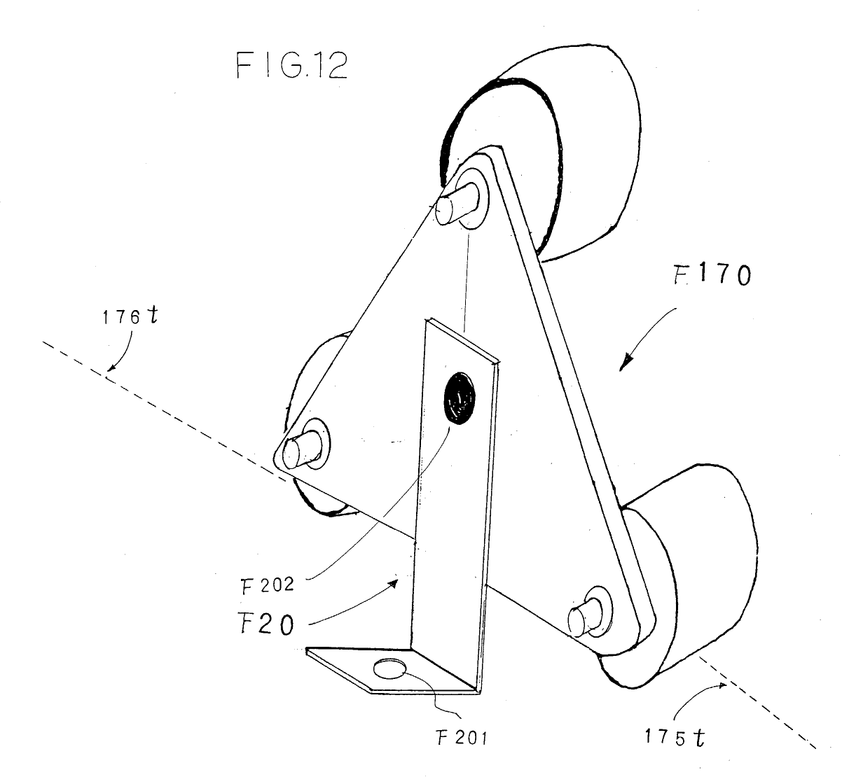

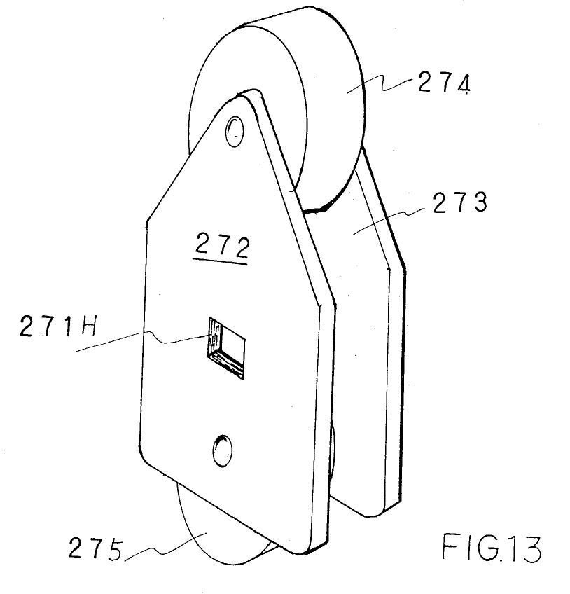

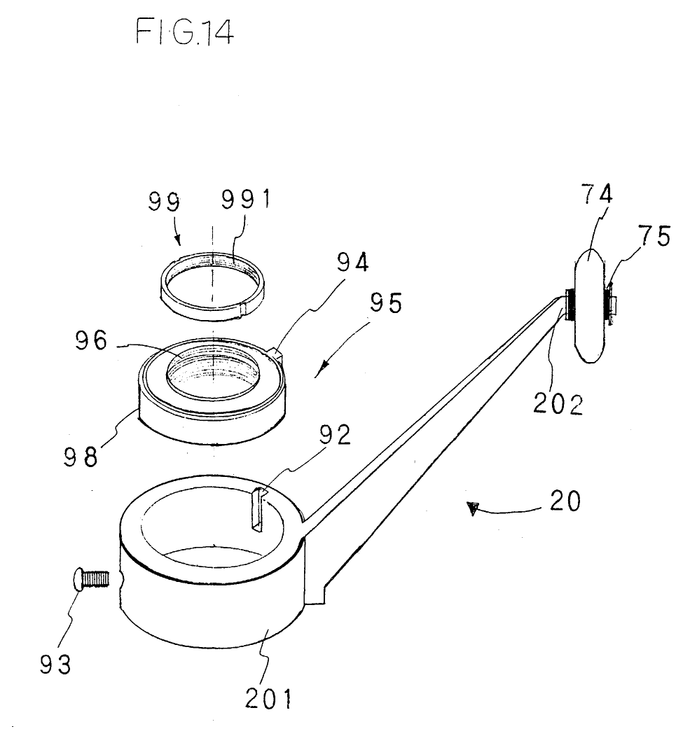

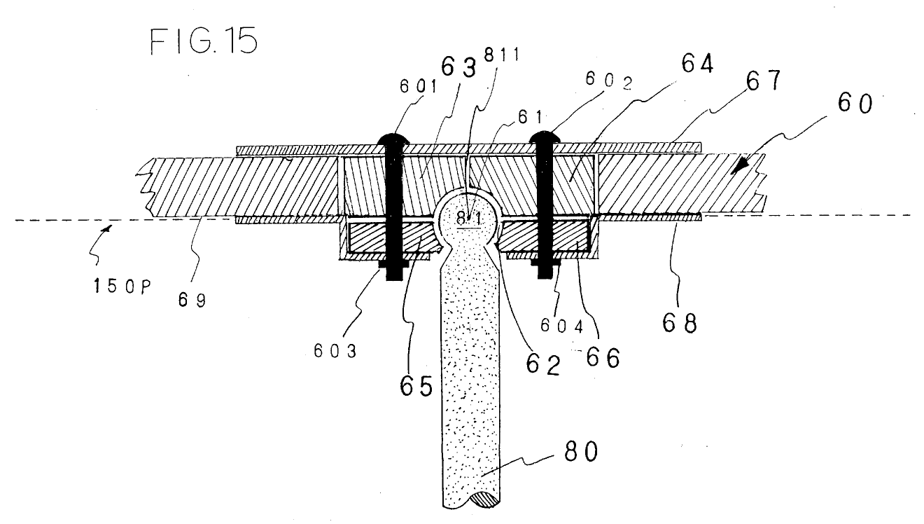

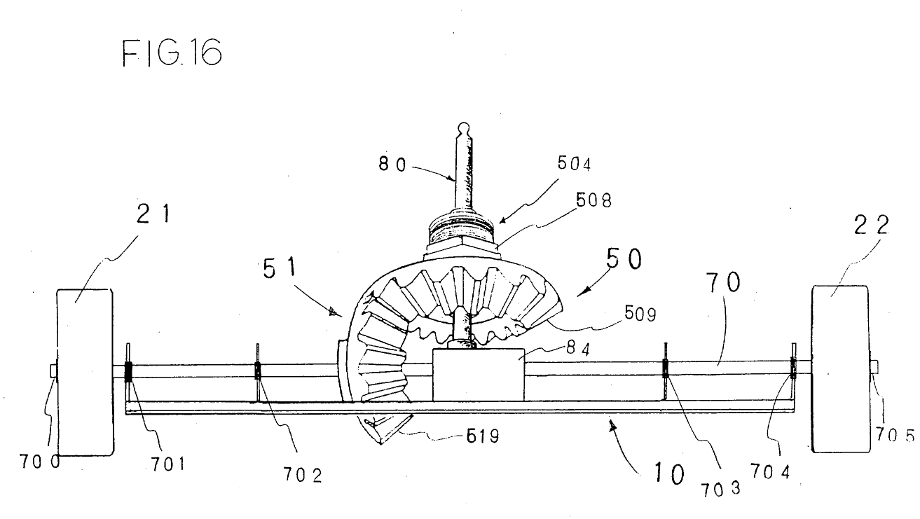

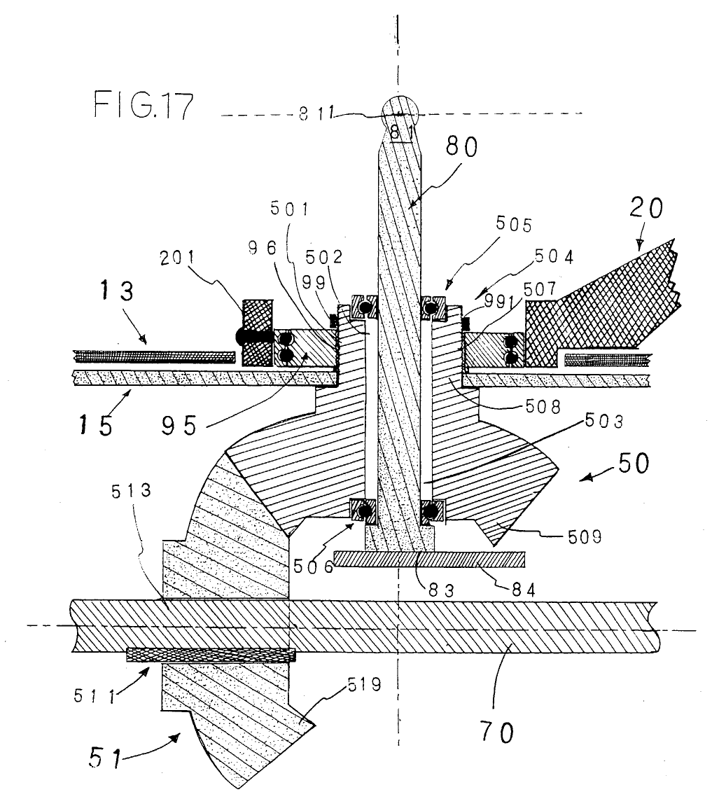

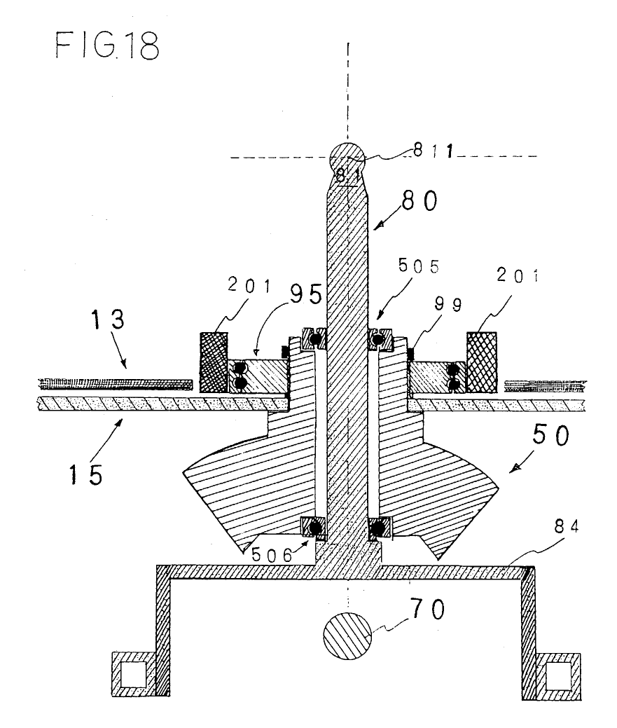

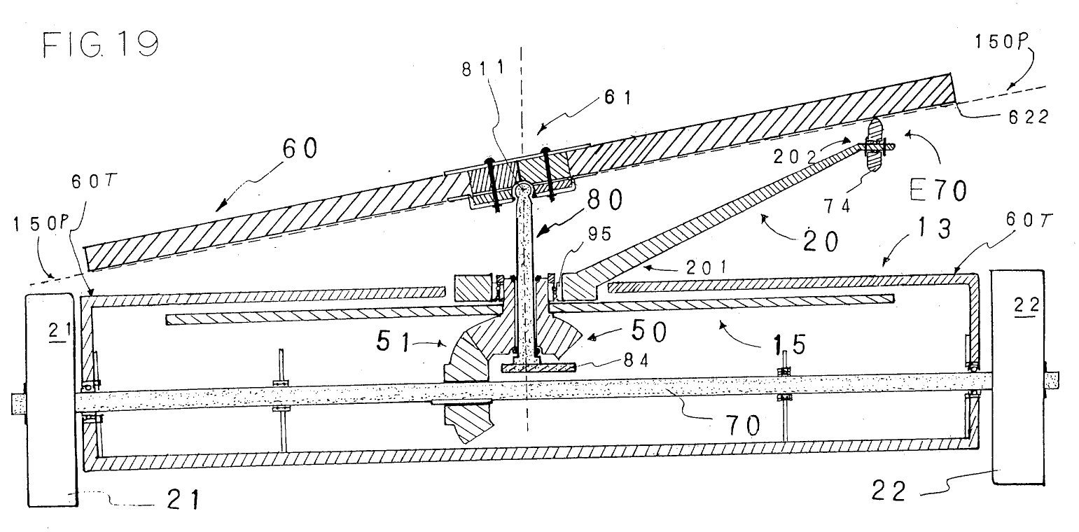

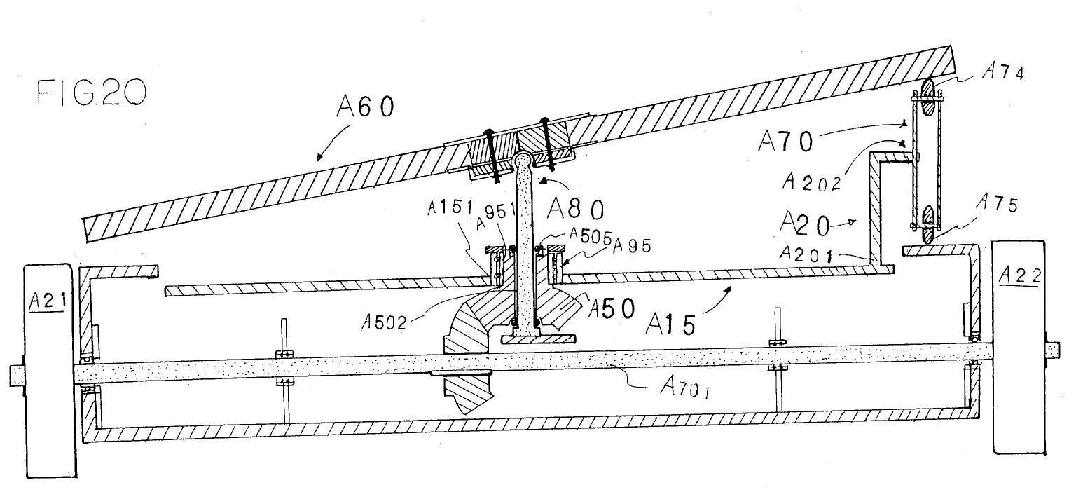

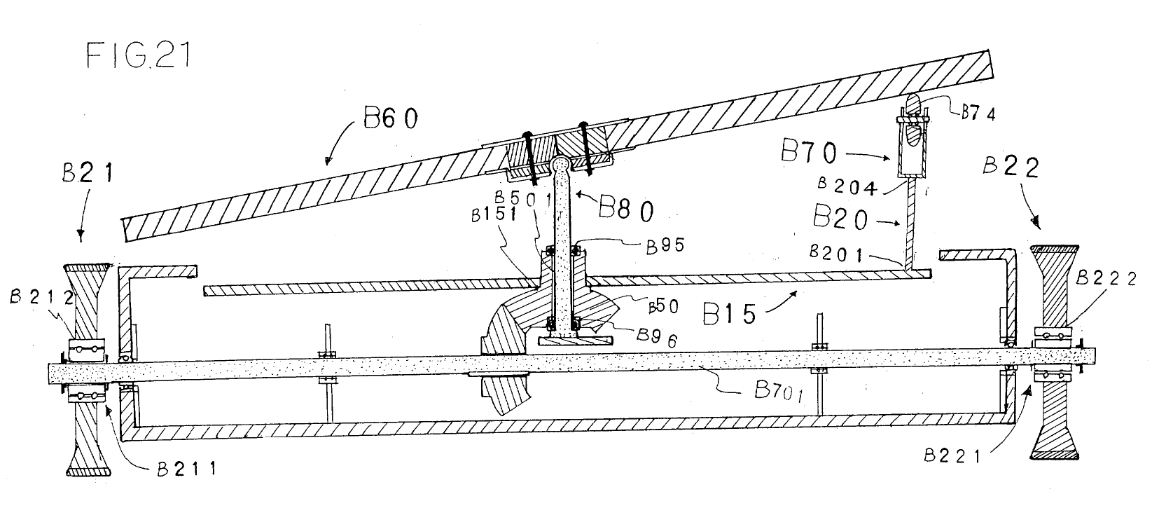

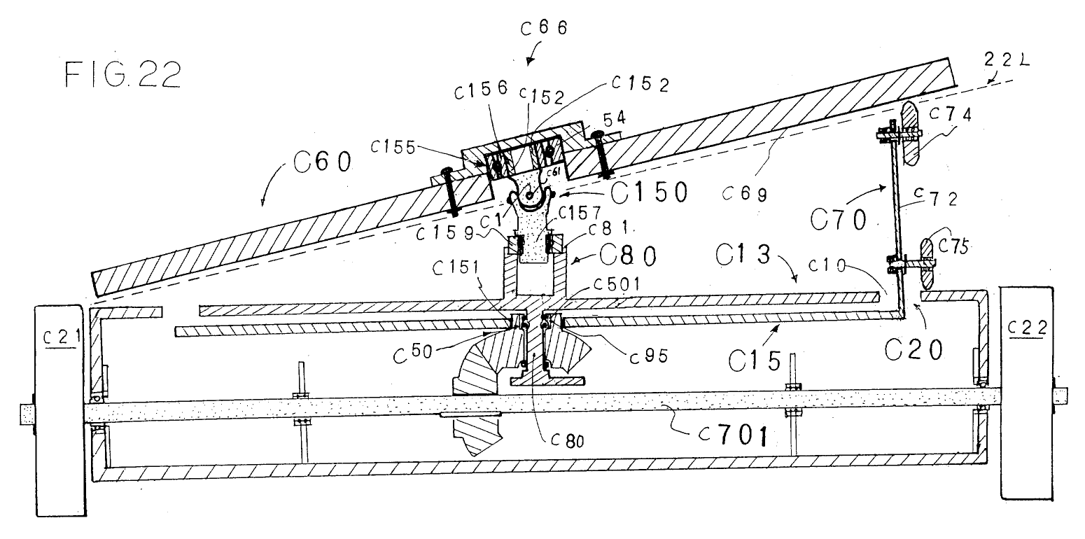

One thing is very essential and critical to the function of footboard 60 centre 61: The joint point 159 of the universal joint 150 (show in FIG. 8) or centre point 811 of the ball-shaped head 81 of shaft 80 (shown in FIG. 19) should be always arranged on the level 150P of lower surface 622 of footboard 60. (This is a plane surface for rotatable wheel 74 to touch and roll under it 60.)

Only in this arrangement, the centre point 61 of footboard 60 will be a centre of tilting and grounding. (When the player tilts his heels and toes on footboard 60, the circumference of said footboard 60 in its lower surface 150P will tilt and ground on resisting board 13.) Only with this arrangement, the footboard 60 itself will not turn around when it 60 grounds each point of its circumference on the resisting board 13 in turn. Or, otherwise, if the centre point 61 of footboard 60 is not configured in the centre 811 of tilting and grounding motion of footboard 60 (such as higher or lower then the level of lower surface 150P of footboard 60.), the footboard 60 will always tilt and ground in an “off centre” condition. Then, the footboard 60 will not only tilt but also rotate itself and mash the resisting board 13 by each point of its circumference in turn. In these cases, a player is not able to stand on the footboard 60 which is keeping rotating. (Or motion of the footboard 60 will be stuck by the player's weight then said footboard 60 is unable to depress the driver unit 70 sideways. Stocking of the footboard 60 happens specially in the case that the centre point 811 of ball-shaped head or joint point C1 in FIG. 22 are configured higher than the level 150P,22L of lower surface 69 of footboard 60.)

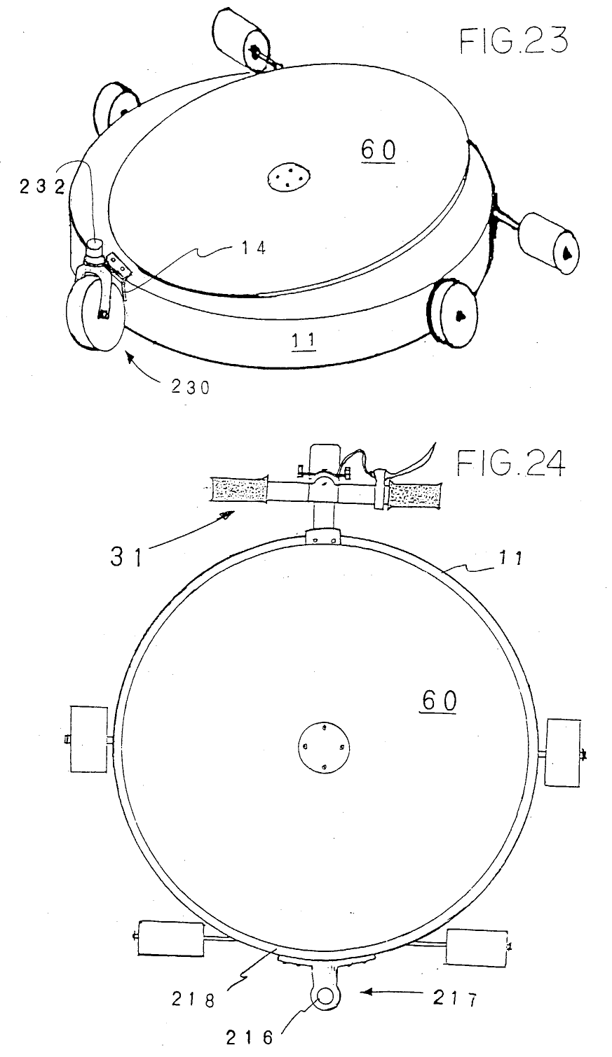

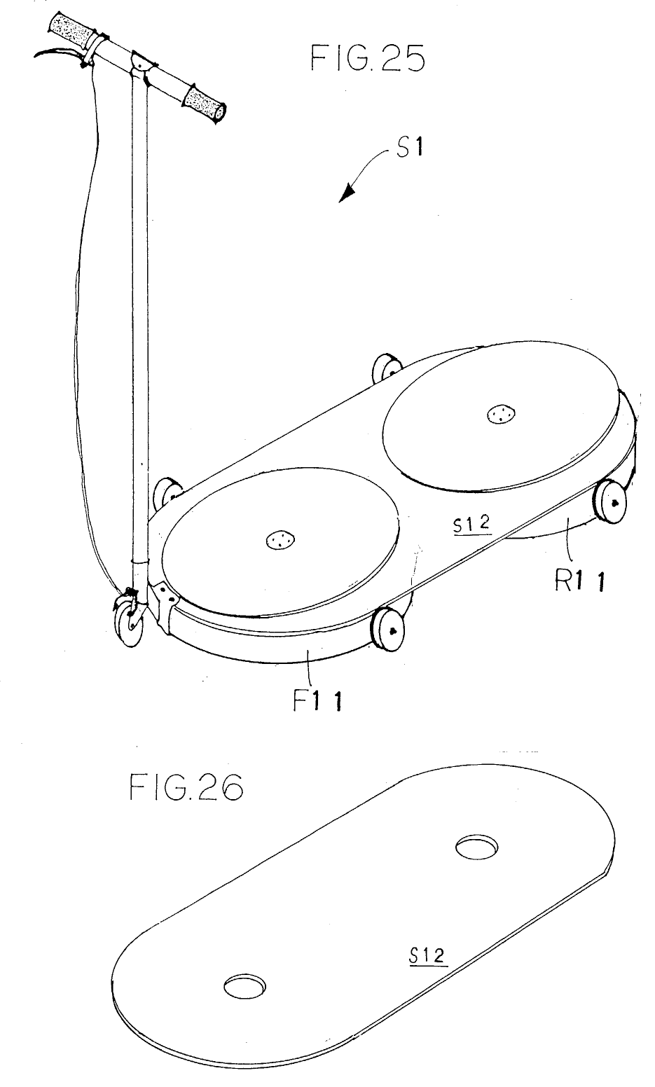

Another critical essential is: (please see the FIG. 9) In case the driver unit 170 grounds the resisting board with two or multiple of rotatable wheels, the straight tracks 175T,176T of each single rotatable wheel 175,176 should be arranged tangently to the circle track 60T on the resisting board respectively. (The circle track 60T is shown in FIG. 11. The rotatable wheel 174 <also see FIG. 9>, which withstand and touch to the footboard 60, moves circularly and this motion projects a circle track 60T on resisting board 13. It is the circle track 60T.) In this way, the driver unit 74,75,202 will move and rotate around the shaft 80 efficiently when someone plays the vehicle 1 (shown in FIG. 1). If the rotatable wheels 175T,176T are not respectively arranged in different tangent line, the driver unit 170 will be stuck and unable to move circularly on resisting board. (Same condition to the driver unit F170 in FIG. 12, the straight tracks 175t,176t should be respectively arranged tangently to the circle track on resisting board.)

The rotation arm 20 can only drive the vehicle in one rotary direction. If someone operates the rotation arm 20 in reverse direction, it will rotate in neutral only It also means that, if bevel gear 51 of the vehicle 1 runs faster than the rotation of bevel gear 50, the rotation arm 20 will not be driven reversely by driven wheels 21,22 and the bevel gear 51. This function enables the rider optionally not to twist his waist to drive the vehicle 1. He may choose to coast this vehicle I with his one foot propelling on the ground another standing on the footboard 60.

Because there is a free wheeler unit (some occasions, a ratchet to substitute) facilitated in a set of mechanism to transmit rotary motion, a player's waist-swiveling can be clockwise or anti-clockwise. So, a “free wheeler” includes kinds of ratchet, kinds of free wheel system. As long as the unit has the function of transmitting only one directional driven strength and neutralizing reversed drive, it is named free wheeler or free wheel system. In claim 1,:”. . . g) a set of mechanism for motion transmission, including at least one free wheeler, and with one element driven by said rotation arm.”) When a player chooses to swivel her (his) waist clockwise, the vehicle will be driven and run. When a player chooses to swivel her (his) waist anti-clockwise, the vehicle will not move. With this function, the vehicle 1 can be used as a stationary exerciser indoors.

Two of the vehicle 1 can be linked together in line—one in front, the other in rear. Two players propel the vehicles FIGS. 23,24 separately with their waist-swiveling to drive the two vehicles FIGS. 23,24 in line. (shown in FIG. 23, FIG. 24) If players like to play the “twin vehicles”, firstly, in advance, the steering device 30 (steering device 30, see FIG. 11) of the vehicle in rear (shown in FIG. 23) has to be detached, and then assemble a special designed front wheel 230 on the forward most 14 of the vehicle. (Or do not have to detach the steering device 30, if the steering device 30 has already configured a coupler means for coupling to the front vehicle in line.) The vehicle in front (shown in FIG. 24) has to be assembled a female coupler unit 217 on tail portion 218 of the drum-shaped shell 11. The female coupler unit 217 couples to short stem 232 by a sleeve 216, then the two vehicles are in a line. The player in front steers the handlebar 31; the player in rear may put hands on the front player's shoulder. Both of the players twist their waists separately and freely; then the two vehicles are cooperatively driven forward by the two players.

The “twin vehicles” (shown in FIG. 23, FIG. 24) can also be made in one vehicle—a “Siamese twin vehicle” (show in FIG. 25). This vehicle S1 has two drum-shaped main body F11,R11 linked together—one in front, the other in rear. Construction of the two main bodies F11,R11 are complete the same as the vehicle 1 in FIG. 11, except the resisting board S12. The two drum-shaped main bodies F11,R11 share one resisting board S12.

Both of two players twist their waists separately and freely, one in front, the other in rear. The player in rear may put hands on the front player's shoulder. Then the “Siamese twin vehicle” is driven forward by the two players. By this invention, waist-twisting exercise becomes an entertainment and can be an outdoor sport among men and women, boys and girls in a specially designed game.

It will be appreciated that the invention broadly consists in the parts, elements and features described in this specification, and is deemed to include any equivalents known in the art which, is substituted for the described integers, would not materially alter the substance of the invention.

I claim:

1. A self-propelled vehicle driven by twisting of human waist, comprising in combination:
a) a main body frame for assembling other units, coupled to at least three wheels for supporting said main body by rotary couplers; and at least one of said wheels is steelable,
b) a shaft with a coupler top end, with a bottom end vertically firmly joined said main body frame,
c) a footboard with a receiving coupler configured in centre thereof, coupling to said coupler top end of said shaft, enabling the under surface of said footboard tilt around centre of said coupler top end of said shaft,
d) a resisting board configured under said footboard, with at least an annular shape of plane surface,
e) a driver unit, including at least one rotatable wheel and corresponding axle therein, and at least one supporting body to support said axle, said driver unit configured between said footboard and said resisting board, with at least one of said rotatable wheel withstanding said footboard, and enabling said footboard to depress said driver unit then push said driver unit to move,
f) a rotation arm with a first end coupled to said shaft by rotary coupler, with a second end joined said driver unit,
g) a set of mechanism for motion transmission, including at least one free wheeler, and with one element driven by said rotation arm.

2. The self-propelled vehicle according to claim 1, wherein the upper end of said shaft couples to centre of said footboard by a universal joint and a ball bearing, inner ring of said ball bearing secures upper end of said universal joint, and outer ring of said ball bearing is secured by a hole in centre of said footboard, enabling the under surface of said footboard tilt around joint point of said universal joint.

3. The self-propelled vehicle according to claim 1, wherein the upper end of said shaft is a ball-shaped head, said receiving coupler is composed by at least two blocks of bushes.

4. The self-propelled vehicle according to claim 1, wherein said wheels for supporting said main body frame: the front wheel of said wheels is a sort of bicycle-like steering wheel assembly having a bicycle brake kits.

5. The self-propelled vehicle according to claim 1, wherein a rotation arm with a first end coupled to said shaft by rotary coupler, said rotary coupler is a free wheel or a ratchet.

6. The self-propelled vehicle according to claim 1, wherein said footboard with a hole in centre, said hole secures around outer ring of a ball and socket joint, said shaft joins center of said ball and socket joint.

7. The self-propelled vehicle according to claim 1, wherein said rotation arm extending with angle of elevation, with a first end coupled to said shaft by rotary coupler, with a second end joined said driver unit.

8. The self-propelled vehicle according to claim 7, wherein said driver unit has one rotatable wheel, said second end of rotation arm acts as an axle of said rotatable wheel.

9. The self-propelled vehicle according to claim 1, wherein said driver unit has at least two rotatable wheels, with said supporting body joined said second end of rotation arm.

10. The self-propelled vehicle according to claim 1, wherein a set of motion transmission mechanism further comprising a fly wheel rotating in concert.

11. The self-propelled vehicle according to claim 10, wherein said fly wheel replaces said rotation arm; driver unit configured on circumference of said fly wheel; centre bore of said fly wheel couples to said shaft by said rotary coupler.

12. The self-propelled vehicle according to claim 10, wherein a set of motion transmission mechanism with one element driven by said rotation arm, said element is a fly wheel coupling to said shaft with a coupler of free wheel or a ratchet.

13. The self-propelled vehicle according to claim 10, wherein said rotation arm with a first end joined one point on circumference of said fly wheel, with a second end joined said driver unit.

14. The self-propelled vehicle according to claim 1, wherein a set of motion transmission mechanism, with one element driven by said rotation arm, said element is a hollowed bevel gear retaining at least one ball bearing to couple to said shaft.

15. The self-propelled vehicle according to claim 1, wherein a set of motion transmission mechanism including gear or belt mechanism.

16. The self-propelled vehicle according to claim 1, wherein a set of mechanism for motion transmission, including free wheels configured in said driven wheels respectively.

17. A method of motion transmission to transmit human body's waist-twisting motion into a circular motion, comprising the steps of:
the first step: providing a device for one person with his two feet standing on, said device including,
a) a main body frame with bracket for supporting following units,
b) a shaft with a coupler top end, with a bottom end vertically firmly joined to said main body frame,
c) a footboard with a receiving coupler configured in centre thereof, coupling to said coupler top end of said shaft, enabling the under surface of said footboard tilt around centre of said coupler top end of said shaft,
d) a resisting board configured under said footboard, with at least an annular shape of plane surface,
e) a driver unit, including at least one rotatable wheel and corresponding axle therein, and at least one supporting body to support said axle; said driver unit configured between said footboard and said resisting board, with at least one of said rotatable wheel withstanding said footboard, and enabling said footboard to depress said driver unit then push said driver unit to move,
f) a rotation arm with a first end coupled to said shaft by rotary coupler, with a second end joined said driver unit,
the second step: standing on said footboard and twisting waist, and then tilting heels and toes to force each point of circumference of said footboard to ground on said resisting board in turn, and meanwhile, depressing said driver unit with said footboard sideways in a same direction; therefore, said driver unit moves tangentially toward the highest point on the circumference of said footboard then drives said rotation arm to produce circular motion.

18. The method as defined in claim 17, wherein said rotation arm further contacting one element of mechanism for motion transmission, means for transmitting circular motion out of said device.

19. The method as defined in claim 18, wherein said circular motion is transmitted to nothing, means for adapting said method of motion transmission as a purpose of exercise or entertainment.

20. A self-propelled vehicle substantially as herein described with reference to the accompanying drawings.
